(19) United States
(12) Patent Application Publication
(10) Pub. No.: US 2021/0067002 A1
(43) Pub. Date: Mar. 4, 2021

(54) ROTATING ELECTRIC MACHINE WITH BRUSH

(71) Applicant: Mitsubishi Electric Corporation, Tokyo (JP)

(72) Inventors: Hiroyuki HIGASHINO, Tokyo (JP); Jun TAHARA, Tokyo (JP); Tatsuya FUKASE, Tokyo (JP); Yoshinobu UTSUMI, Tokyo (JP); Tomoaki SHIMANO, Tokyo (JP)

(73) Assignee: Mitsubishi Electric Corporation, Tokyo (JP)

(21) Appl. No.: 16/964,845

(22) PCT Filed: Mar. 23, 2018
(86) PCT No.: PCT/JP2018/011738

§ 371 Date: Jul. 24, 2020

(51) Int. Cl. H02K 9/06; H02K 9/197; H02K 5/14; H02K 5/20

(52) U.S. Cl. CPC H02K 9/06; H02K 5/20; H02K 5/141; H02K 9/197

(57) ABSTRACT

A heat-generating-component cooling flow passage and a bearing cooling flow passage are formed by mounting a flow passage cover to a rotor unit side of a rear bracket-cum-cooler. An arrangement region of the bearing cooling flow passage in an axial direction of the rotary shaft is arranged so as to overlap with at least a part of an arrangement region of a rear bearing in the axial direction of the rotary shaft. The heat-generating-component cooling flow passage is arranged so as to overlap with at least a part of an arrangement region of a heat generating component when viewed in the axial direction of the rotary shaft. A stator core is connected to the heat-generating-component cooling flow passage through the rear bracket-cum-cooler.

### TECHNICAL FIELD

The present invention relates to a rotating electric machine with a brush (herein after referred to as “brushed rotating electric machine”), which includes a rotating machine unit and a power converter, and more particularly, to a cooling structure for heat generating components of the power converter, brushes, and a bearing on a side on which the brushes are provided.

### BACKGROUND ART

A rotating electric machine including heat generating components has a cooling structure for cooling the heat generating components. For example, a vehicle AC power generator described in Patent Literature 1 includes a housing, a front bracket, a rotor, a stator, brushes, and a rear bracket. The housing has a bottomed cylindrical shape. The front bracket is provided so as to close an opening of the housing. The rotor is secured to a rotary shaft supported by bearings, and is accommodated in the housing. The bearings are mounted to a bottom portion of the housing and the front bracket, respectively. The stator is accommodated and held in a cylindrical portion of the housing, and is provided on a radially outer side of the rotor. The brushes are slidably mounted to a slip ring provided to a projecting portion of the rotary shaft, which projects from the bottom portion of the housing. The rear bracket is fixed to the housing so as to cover the brushes. Grooves serving as flow passages formed in the cylindrical portion and the bottom portion of the housing are closed by a rear plate on a side of the housing, which is opposite to the front bracket, to thereby form sealed flow passages. A diode and an IC regulator, which correspond to heat generating components, are fixed to a rear bracket side of the rear plate. Further, a good thermal conductor is provided between a stator winding and the housing so as not to leave any gap.

In the vehicle AC power generator described in Patent Literature 1, cooling water is caused to flow through the sealed flow passages formed by the housing and the rear plate to thereby cool the stator winding, the diode, and the IC regulator.

### CITATION LIST

### Patent Literature

[PTL 1] JP 2003-324873 A

### SUMMARY OF INVENTION

### Technical Problem

In the vehicle AC power generator described in Patent Literature 1, the flow passage is formed in the cylindrical portion of the housing, which is located on an outer side of the stator. Thus, a radial dimension of the power generator is increased. Because of a demand for a reduction in size in recent years, it is difficult to increase a radial dimension of the flow passage formed in the cylindrical portion of the housing.

Further, the flow passages configured to cool the heat generating components such as the diode and the IC regulator are formed by the bottom portion of the housing and the rear plate. Thus, when the cooling water is caused to flow through the flow passage formed in the bottom portion of the housing, which branches from the flow passage formed in the cylindrical portion of the housing, a shape of a branching portion becomes complex to equalize a flow of the cooling water flowing in both of the flow passages. Further, when the flow passages are connected in series, the flow passages have a long total length. Thus, a pressure loss is increased. As a result, the heat generating components cannot be cooled with high efficiency.

The present invention has been made to solve the problems described above, and has an object to provide a brushed rotating electric machine, which has a small size and is capable of cooling heat generating components with high efficiency.

### Solution to Problem

According to one embodiment of the present invention, there is provided a brushed rotating electric machine, including: a rotating machine unit; a power converter arranged on a rear side of the rotating machine unit; and a cooling unit arranged between the rotating machine unit and the power converter. The rotating machine unit includes: a front bracket, which is formed in a bowl-like shape and has a front-side fitting portion formed at an opening edge, and in which a front bearing is mounted at an axial center position; a rear bracket-cum-cooler, which is formed in a bowl-like shape and has a rear-side fitting portion formed at an opening edge, and in which a rear bearing is mounted at an axial center position, a rotor unit including: a rotor core; a rotary shaft inserted into the rotor core at an axial center position to be integrated with the rotor core; and a field winding mounted to the rotor core, the rotary shaft being supported by the front bearing and the rear bearing so as to be rotatably arranged; and a stator unit including: a stator core; and a stator winding mounted to the stator core, the stator unit being pressurized and sandwiched between the front bracket and the rear bracket-cum-cooler on both sides in an axial direction of the rotary shaft under a state in which outer peripheral edge portions of both end portions of the stator core are fitted to the front-side fitting portion and the rear-side fitting portion to be arranged coaxially with the rotor unit so as to surround the rotor unit. The power converter includes: at least one heat generating component to be mounted on a surface of the rear bracket-cum-cooler on a side opposite to the rotor unit; a slip ring mounted to a projecting portion of the rotary shaft, which projects from the rear bearing; a brush holder provided on an outer peripheral side of the slip ring; brushes held in the brush holder so as to be in contact with the slip ring; and a power converter cover mounted to the rear bracket-cum-cooler, which is configured to cover the heat generating component, the brushes, and the brush holder. The cooling unit includes a heat-generating-component cooling flow passage and a bearing cooling flow passage, which are formed by mounting a flow passage cover to the rotor unit side of the rear bracket-cum-cooler. The flow passage cover has a dimension that is equal to or smaller than an inner diameter of the rear-side fitting portion and is larger than an outer diameter of the rotary shaft. The bearing cooling flow passage is an arc-shaped flow passage along a circumferential direction of the rotary shaft, and is arranged so that an arrangement region of the bearing cooling flow passage in an axial direction of the rotary shaft overlaps with at least a part of an arrangement region of the rear bearing in the axial direction of the rotary shaft, and the heat-generating-component cooling flow passage is arranged so as to overlap with at least a part of an arrangement region of the heat generating component when viewed in the axial direction of the rotary shaft.

### Advantageous Effects of Invention

According to the present invention, it is not required that a cooling flow passage be formed on a radially outer side of the stator unit, and hence a radial dimension can be reduced. Further, a flow passage structure of the cooling flow passages can be achieved with a simple structure, and hence a pressure loss can be suppressed. Thus, the heat generating components can be cooled with high efficiency.

### BRIEF DESCRIPTION OF DRAWINGS

FIG. 1 is a perspective view for illustrating a brushed rotating electric machine according to a first embodiment of the present invention.

FIG. 2 is an exploded perspective view for illustrating the brushed rotating electric machine according to the first embodiment of the present invention.

FIG. 3 is a sectional view taken along the line A-A of FIG. 1 when viewed in the direction of arrows.

FIG. 4 is a sectional view for illustrating a brushed rotating electric machine according to a second embodiment of the present invention.

FIG. 5 is an enlarged sectional view of a portion B of FIG. 4.

FIG. 6 is an exploded perspective view for illustrating a brushed rotating electric machine according to a third embodiment of the present invention.

FIG. 7 is a sectional view for illustrating the brushed rotating electric machine according to the third embodiment of the present invention.

FIG. 8 is an enlarged sectional view for illustrating a main part of a brushed rotating electric machine according to a fourth embodiment of the present invention.

FIG. 9 is a sectional view for illustrating a brushed rotating electric machine according to a fifth embodiment of the present invention.

FIG. 10 is a sectional view for illustrating a first modification example of the brushed rotating electric machine according to the fifth embodiment of the present invention.

FIG. 11 is a sectional view for illustrating a second modification example of the brushed rotating electric machine according to the fifth embodiment of the present invention.

FIG. 12 is a sectional view for illustrating a third modification example of the brushed rotating electric machine according to the fifth embodiment of the present invention.

FIG. 13 is a sectional view for illustrating a fourth modification example of the brushed rotating electric machine according to the fifth embodiment of the present invention.

FIG. 14 is a sectional view for illustrating a brushed rotating electric machine according to a sixth embodiment of the present invention.

FIG. 15 is an enlarged sectional view for illustrating a main part of a brushed rotating electric machine according to a seventh embodiment of the present invention.

### DESCRIPTION OF EMBODIMENTS

Now, embodiments of the present invention are described with reference to the drawings. The embodiments of the present invention are not limited by the following description. A shape and an arrangement of each of components described in the specification are merely examples, and are not limited by the description thereof.

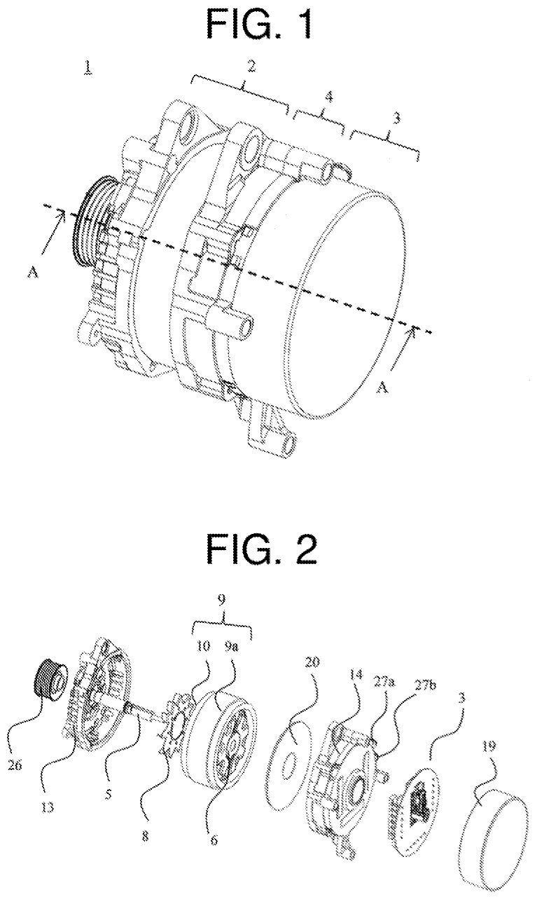

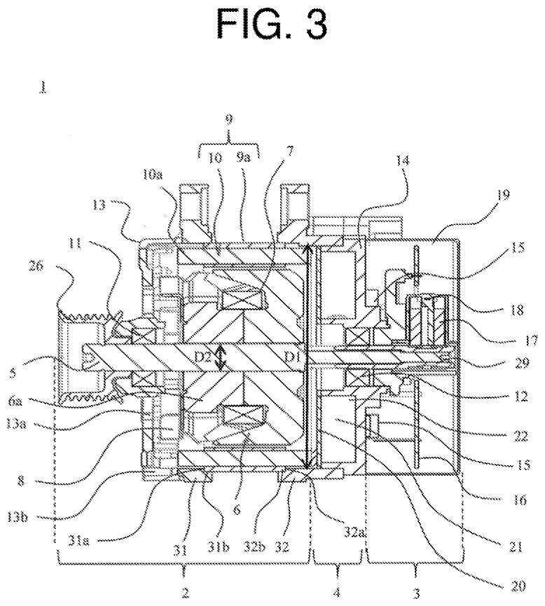

FIG. 1 is a perspective view for illustrating a brushed rotating electric machine according to a first embodiment of the present invention. FIG. 2 is an exploded perspective view for illustrating the brushed rotating electric machine according to the first embodiment of the present invention. FIG. 3 is a sectional view taken along the line A-A of FIG. 1 when viewed in the direction of arrows.

In FIG. 1, a brushed rotating electric machine 1 includes a rotating machine unit 2, a power converter 3, and a cooling unit 4. Although not shown, the rotating machine unit 2 operates as a motor configured to drive a gear device or an internal combustion engine, which is connected to a pulley 26, or assist driving thereof, or a power generator to be driven by the gear device or the internal combustion engine. The power converter 3 operates as an inverter configured to control the rotating machine unit 2 or a converter configured to convert electric power generated by the rotating machine unit 2.

The rotating machine unit 2 includes, as illustrated in FIG. 2 and FIG. 3, a rotor unit 6, a stator unit 9, a front bracket 13, and a rear bracket-cum-cooler 14. The stator unit 9 surrounds the rotor unit 6. The front bracket 13 and the rear bracket-cum-cooler 14 are configured to hold the rotor unit 6 and the stator unit 9.

The front bracket 13 is produced to have a bowl-like shape by, for example, casting or die casting of a metal material such as aluminum. A front bearing 11 is mounted at an axial center position of the front bracket 13. Further, a front-side fitting portion 31 is formed at an opening edge of the front bracket 13. The front-side fitting portion 31 has an axial fitting surface 31a having an annular shape and a radial fitting surface 31b having a cylindrical shape. The axial fitting surface 31a is formed of a flat surface orthogonal to an axial direction of a rotary shaft 5. The radial fitting surface 31b is formed of a cylindrical surface having an axial center of the rotary shaft 5 as a center.

The rear bracket-cum-cooler 14 is produced to have a bowl-like shape by, for example, casting or die casting of a metal material such as aluminum. A rear bearing 12 is mounted at an axial center position of the rear bracket-cum-cooler 14. Further, a rear-side fitting portion 32 is formed at an opening edge of the rear bracket-cum-cooler 14. The rear-side fitting portion 32 has an axial fitting surface 32a having an annular shape and a radial fitting surface 32b having a cylindrical shape. The axial fitting surface 32a is formed of a flat surface orthogonal to the axial direction of the rotary shaft 5. The radial fitting surface 32b is formed of a cylindrical surface having the axial center of the rotary shaft 5 as a center.

The stator unit 9 includes a stator core 9a having an annular shape and a stator winding 10 mounted inside the stator core 9a. Winding exposed portions 10a of the stator winding 10 are exposed from both ends of the stator core 9a. The stator unit 9 is pressurized and sandwiched between the front bracket 13 and the rear bracket-cum-cooler 14 on both sides of the stator core 9a in the axial direction to be held therebetween under a state in which outer peripheral edge portions of both ends of the stator core 9a in the axial direction are fitted to the front-side fitting portion 31 and the rear-side fitting portion 32, respectively. In this case, the outer peripheral edge portions of the both end surfaces of the stator core 9a are pressurized and sandwiched between the axial fitting surfaces 31a and 32a on both sides in the axial direction. Further, both end edge portions of an outer peripheral surface of the stator core 9a are fitted to the radial fitting surfaces 31b and 32b to thereby perform positioning in a radial direction of the stator core 9a.

The rotor unit 6 includes a rotor core 6a, a field winding 7, and the rotary shaft 5. The field winding 7 is wound around the rotor core 6a. The rotary shaft 5 is inserted at an axial center position of the rotor unit 6, and is co-rotatably secured to the rotor core 6a. Both ends of the rotary shaft 5 are rotatably supported by the front bearing 11 and the rear bearing 12, respectively. The front bearing 11 is mounted in the front bracket 13. The rear bearing 12 is mounted in the rear bracket-cum-cooler 14. In this manner, the rotor unit 6 is arranged on a radially inner side of the stator unit 9 through an air gap portion so as to be coaxial with the stator unit 9. Further, the pulley 26 is mounted to a front-side end portion of the rotary shaft 5. Further, a front fan 8 to be driven by the rotary shaft 5 to generate cooling air is mounted to an axial end surface of the rotor core 6a on a front side. An intake hole 13a configured to take air to an inside with use of rotation of the front fan 8 as motive power is formed in a surface of the front bracket 13, which is opposed to the front fan 8. Further, a discharge hole 13b configured to discharge air is formed in a portion of the front bracket 13 on a radially outer side of the front fan 8.

The rotary shaft 5 projects from the rear bracket-cum-cooler 14 toward a side opposite to the rotor core 6a. A slip ring 29 is mounted to a projecting portion of the rotary shaft 5. The slip ring 29 is configured to supply a current to the field winding 7. Brushes 17 are held in a brush holder 18, and are in contact with the slip ring 29 under a slidably contactable state.

The power converter 3 includes a board 16 and heat generating components 15. The heat generating components 15 are mounted on a surface of the rear bracket-cum-cooler 14 of the rotating machine unit 2 on a side opposite to the rotor core 6a, and are electrically connected to the board 16 through, for example, a bus bar. Further, the board 16 is electrically connected also to the brushes 17. Through the electrical connection, an alternating current supplied from an external power supply is converted into a direct current by the heat generating components 15, and is supplied to the brushes 17. Further, a power converter cover 19 is mounted to the rear bracket-cum-cooler 14 so as to cover the board 16, the heat generating components 15, the brushes 17, and the brush holder 18.

In this case, the heat generating components 15 include, for example, a switching element such as a MOS-FET, a smoothing capacitor, a noise removing coil, and a power relay. The heat generating components 15 are electrically connected to the board 16 to form a desired circuit such as an inverter circuit or a converter circuit.

The cooling unit 4 includes the rear bracket-cum-cooler 14, a flow passage cover 20, a flow passage inlet 27a, and a flow passage outlet 27b. The flow passage cover 20 is produced with a metal such as aluminum, which is a good thermal conductive material, as in the case of the rear bracket-cum-cooler 14. The flow passage cover 20 has a dimension that is equal to or smaller than an inner diameter D1 of the rear-side fitting portion 32 of the rear bracket-cum-cooler 14 and is larger than an outer diameter D2 of the rotary shaft 5. A groove for forming flow passages is formed in a surface of the rear bracket-cum-cooler 14 on the rotor unit 6 side. The groove for forming the flow passages is closed by mounting the flow passage cover 20 to the rear bracket-cum-cooler 14 to thereby form cooling flow passages. The cooling flow passages include a heat-generating-component cooling flow passage 21 and a bearing cooling flow passage 22. The heat-generating-component cooling flow passage 21 is formed at such a position as to be opposed to a part or all of the heat generating components 15 when viewed in the axial direction of the rotary shaft 5. The bearing cooling flow passage 22 is formed at such a position as to be opposed to a part or entirety of the rear bearing 12 when viewed in a radial direction of the rotary shaft 5. The bearing cooling flow passage 22 is a flow passage having an arc-like shape along a circumferential direction of the rotary shaft 5. The bearing cooling flow passage 22 is formed continuously with the heat-generating-component cooling flow passage 21 on a radially inner side of the heat-generating-component cooling flow passage 21. Specifically, the heat-generating-component cooling flow passage 21 and the bearing cooling flow passage 22 have an integrated structure.

In the brushed rotating electric machine 1 having the configuration described above, when the rotor unit 6 is driven to rotate, the front fan 8 is rotated in association with the rotor unit 6. As a result, air is sucked to an inside of the front bracket 13 through the intake hole 13a. The air, which has been sucked to the inside of the front bracket 13, flows in the axial direction to reach the rotor core 6a, and is diverted by the front fan 8 toward a radially outer side to be discharged to an outside through the discharge hole 13b. At this time, the front bracket 13 is cooled with the flow of air through the intake hole 13a. Through the cooling of the front bracket 13, the front bearing 11 is cooled. Further, a front side of the stator core 9a and the winding exposed portion 10a of the stator winding 10 on the front side are exposed to the flow of air, which is diverted by the front fan 8 in a centrifugal direction to be discharged to the outside through the discharge hole 13b, and are cooled.

Further, cooling water as a liquid refrigerant is supplied through the flow passage inlet 27a to the heat-generating-component cooling flow passage 21, and flows through the heat-generating-component cooling flow passage 21 and the bearing cooling flow passage 22. After that, the cooling water is discharged through the flow passage outlet 27b. With the flow of the cooling water through the heat-generating-component cooling flow passage 21, the heat generating components 15 mounted on the rear bracket-cum-cooler 14 are cooled. Further, with the flow of the cooling water through the bearing cooling flow passage 22, the rear bearing 12 is cooled. As a result of the cooling of the rear bearing 12, a temperature of the rear bearing 12 is decreased to thereby indirectly cool the rotary shaft 5. As a result of the cooling of the rotary shaft 5, the brushes 17 are cooled through the slip ring 29 mounted to an end portion of the rotary shaft 5. Further, through the flow of the cooling water through the heat-generating-component cooling flow passage 21 and the bearing cooling flow passage 22, the rear bracket-cum-cooler 14 is cooled. In this manner, the stator core 9a fitted to the rear bracket-cum-cooler 14 is cooled, and the stator winding 10 is cooled.

According to the first embodiment, the rear bracket-cum-cooler 14 is in contact with the stator core 9a through the rear-side fitting portion 32 provided therebetween. Thus, heat generated in the stator winding 10 is transmitted to the rear bracket-cum-cooler 14 via the stator core 9a, and is released to the cooling water flowing through the heat-generating-component cooling flow passage 21. Thus, a flow passage is not required to be formed on a radially outer side of the stator unit 9. As a result, a reduction in radial dimension of the brushed rotating electric machine 1 can be achieved. Further, only the heat-generating-component cooling flow passage 21 and the bearing cooling flow passage 22 are formed in the rear bracket-cum-cooler 14 as the cooling flow passages. As a result, a flow passage structure can be achieved with a simple structure, and a pressure loss can be suppressed. Thus, the heat generating components 15 can be cooled with high efficiency.

The heat-generating-component cooling flow passage 21 and the bearing cooling flow passage 22 have an integrated structure. With the integrated structure, a single flow-passage system is formed. Thus, the flow passage structure can be achieved with a simple structure, and the pressure loss can be suppressed. Further, the flow passage structure is simplified, and hence restrictions on manufacture, processing, and assembly can easily be suppressed.

Further, in the first embodiment described above, the heat-generating-component cooling flow passage 21 and the bearing cooling flow passage 22 have the integrated structure. The heat-generating-component cooling flow passage 21 and the bearing cooling flow passage 22 may be separate flow passages each independently having a flow passage inlet and a flow passage outlet, or may be flow passages arranged in parallel to have a common flow passage inlet and a common flow passage outlet.

### Second Embodiment

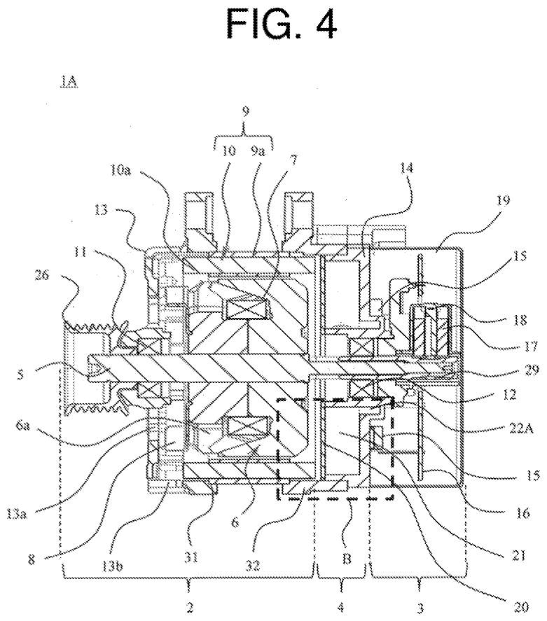

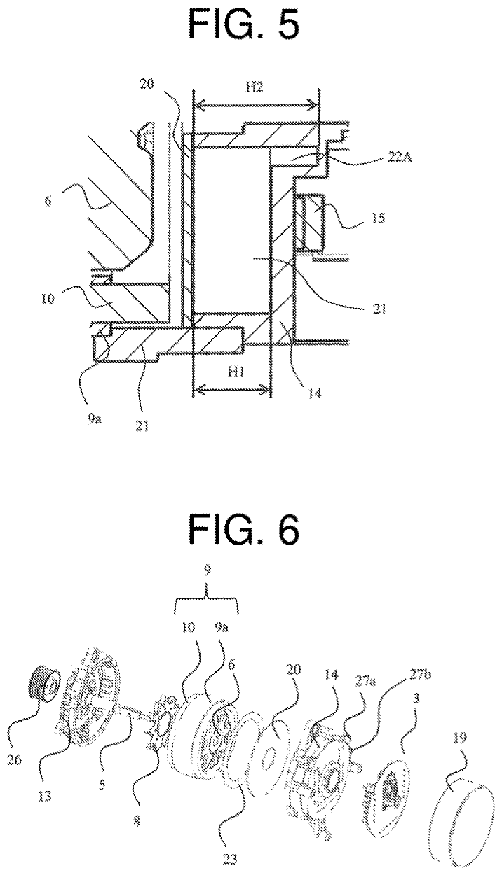

FIG. 4 is a sectional view for illustrating a brushed rotating electric machine according to a second embodiment of the present invention. FIG. 5 is an enlarged sectional view of a portion B of FIG. 5. FIG. 4 is a sectional view corresponding to the sectional view taken along the line A-A of FIG. 1 when viewed in the direction of the arrows.

In this case, the second embodiment is different from the first embodiment only in the configuration of the flow passages. Thus, only differences are described, and description of other parts is omitted.

In FIG. 4 and FIG. 5, a maximum dimension H2 of a bearing cooling flow passage 22A along the axial direction of the rotary shaft 5 is longer than a maximum dimension H1 of the heat-generating-component cooling flow passage 21 along the axial direction of the rotary shaft 5. Specifically, the bearing cooling flow passage 22A, which is formed on the radially inner side of the heat-generating-component cooling flow passage 21 so as to be continuous with the heat-generating-component cooling flow passage 21, extends from the heat-generating-component cooling flow passage 21 toward a side opposite to the stator core 9a.

In a brushed rotating electric machine 1A having the configuration described above, a length of a region of the bearing cooling flow passage 22A, which is opposed to the rear bearing 12, in the axial direction of the rotary shaft 5 is increased. As a result, the rear bearing 12 can be more efficiently cooled. Further, the brushes 17, which are located on a rear side of the rear bearing 12, can also be efficiently cooled.

### Third Embodiment

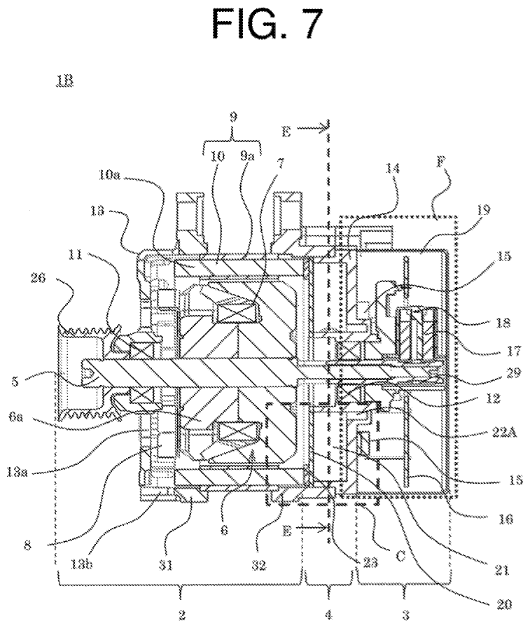

FIG. 6 is an exploded perspective view for illustrating a brushed rotating electric machine according to a third embodiment of the present invention. FIG. 7 is a sectional view for illustrating the brushed rotating electric machine according to the third embodiment of the present invention. FIG. 7 is a sectional view corresponding to the sectional view taken along the line A-A of FIG. 1 when viewed in the direction of the arrows.

In this case, the third embodiment is different from the second embodiment only in the configuration of a portion between the flow passage cover 20 and the stator winding 10. Thus, only differences are described, and description of other parts is omitted.

In FIG. 6 and FIG. 7, a heat-releasing member 23 is arranged between the flow passage cover 20 and the winding exposed portion 10a of the stator winding 10 on the rear side so as to be in contact with the flow passage cover 20 and the winding exposed portion 10a. For the heat-releasing member 23, a material having a thermal conductivity larger than that of air, such as grease or a resin material, is used. However, various kinds and shapes of materials such as a liquid material, a sheet-like material, or a thermosetting material may be used.

In a brushed rotating electric machine 1B having the configuration described above, the heat-releasing member 23 is arranged between the flow passage cover 20 and the winding exposed portion 10a of the stator winding 10 on the rear side so as to be in contact with the flow passage cover 20 and the winding exposed portion 10a. Thus, heat generated in the winding exposed portion 10a of the stator winding 10 on the rear side is transmitted to the cooling water flowing through the heat-generating-component cooling flow passage 21 via the heat-releasing member 23 and the flow passage cover 20. As a result, the stator winding 10 is more efficiently cooled.

In the third embodiment described above, the heat-releasing member 23 is arranged in the brushed rotating electric machine 1A according to the second embodiment described above. The same effects are obtained even when the heat-releasing member is arranged in the brushed rotating electric machine 1 according to the first embodiment described above.

### Fourth Embodiment

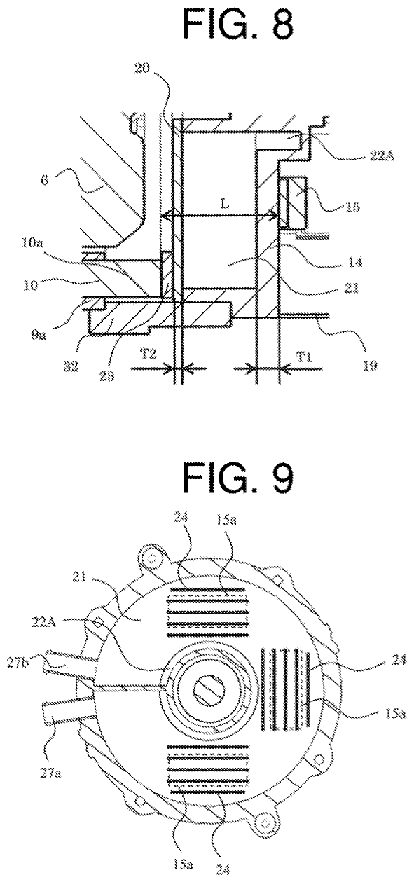

FIG. 8 is an enlarged sectional view for illustrating a main part of a brushed rotating electric machine according to a fourth embodiment of the present invention. FIG. 8 is a sectional view of a main part corresponding to a portion C of FIG. 7.

In this case, the fourth embodiment is different from the third embodiment only in dimension of the flow passage cover 20 and dimension of the rear bracket-cum-cooler 14 in the axial direction of the rotary shaft 5. Thus, only differences are described, and description of other parts is omitted.

In FIG. 8, an axial dimension T1 of a portion of the rear bracket-cum-cooler 14, on which the heat generating components 15 are mounted, is larger than an axial dimension T2 of the flow passage cover 20.

In a brushed rotating electing machine having the configuration described above, the dimension T1 is increased so that a thick portion of the rear bracket-cum-cooler 14 between the heat generating components 15 (heat generating bodies) and the heat-generating-component cooling flow passage 21 (heat releaser) is caused to act as a heat spreader. In this manner, a heat density in the thick portion of the rear bracket-cum-cooler 14 between the heat generating components 15 and the heat-generating-component cooling flow passage 21 can be reduced. Thus, the heat generating components 15 can be more efficiently cooled.

Further, the dimension T2 is reduced, and hence a dimension L can be reduced. As a result, the brushed rotating electric machine can be reduced in size in the axial direction. Further, the flow passage cover 20 can be formed of a thin plate member. Thus, the flow passage cover 20 can more easily be produced with, for example, a sheet metal than that formed by molding with use of a die by, for example, casting or die casting. Thus, component cost can be reduced.

In the fourth embodiment described above, the axial dimension of the flow passage cover 20 and the axial dimension of the rear bracket-cum-cooler 14 are changed in the brushed rotating electric machine according to the third embodiment described above. However, the same effects are obtained even when the axial dimension of the flow passage cover 20 and the axial dimension of the rear bracket-cum-cooler 14 are changed in the brushed rotating electric machines according to the first and second embodiments described above.

### Fifth Embodiment

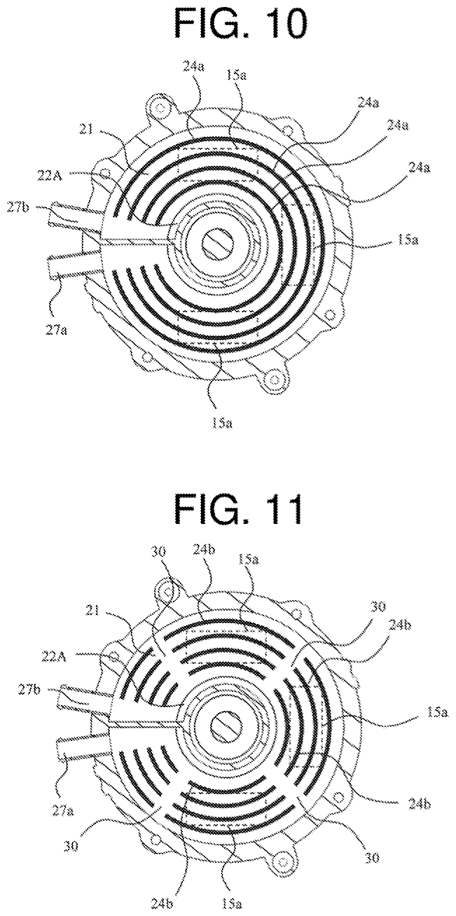

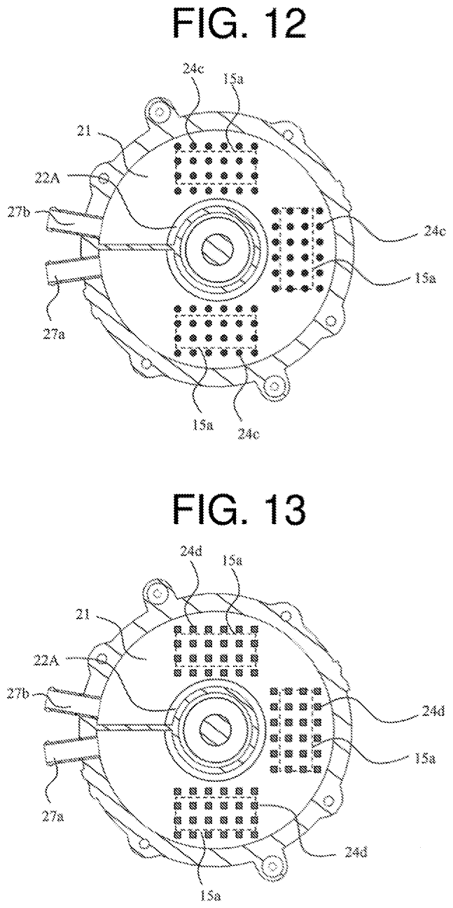

FIG. 9 is a sectional view for illustrating a brushed rotating electric machine according to a fifth embodiment of the present invention. FIG. 10 is a sectional view for illustrating a first modification example of the brushed rotating electric machine according to the fifth embodiment of the present invention. FIG. 11 is a sectional view for illustrating a second modification example of the brushed rotating electric machine according to the fifth embodiment of the present invention. FIG. 12 is a sectional view for illustrating a third modification example of the brushed rotating electric machine according to the fifth embodiment of the present invention. FIG. 13 is a sectional view for illustrating a fourth modification example of the brushed rotating electric machine according to the fifth embodiment of the present invention. FIG. 9 to FIG. 13 are sectional views, each corresponding to a sectional view taken along the line E-E of FIG. 7 when viewed in the direction of arrows.

In this case, the fifth embodiment is different from the third embodiment only in the configuration of the heat-generating-component cooling flow passage 21. Thus, only differences are described, and description of other parts is omitted.

In FIG. 9, heat-generating-component mounting portions 15a are arranged on a surface of the rear bracket-cum-cooler 14 on a side opposite to the heat-generating-component cooling flow passage 21 at intervals in the circumferential direction. The heat-generating-component mounting portions 15a are regions of the surface of the rear bracket-cum-cooler 14 on the side opposite to the heat-generating-component cooling flow passage 21, on which the heat generating components 15 are mounted. A plurality of linear heat-releasing fins 24 are provided at least on each of regions of a surface of the rear bracket-cum-cooler 14 on the heat-generating-component cooling flow passage 21 side, which are opposed to the heat-generating-component mounting portions 15a. The heat-releasing fins 24 are arranged in parallel at intervals in the radial direction.

In the brushed rotating electric machine having the configuration described above, a heat releasing area in the heat-generating-component cooling flow passage 21 is increased by providing the heat-releasing fins 24. As a result, release of heat generated in the heat generating components 15 is accelerated, and hence the heat generating components 15 can be more efficiently cooled.

In the fifth embodiment, as illustrated in FIG. 9, the plurality of linear heat-releasing fins 24 are provided on each of the regions of the surface of the rear bracket-cum-cooler 14 on the heat-generating-component cooling flow passage side, which are opposed to the heat-generating-component mounting portions 15a, so as to be arranged in parallel at intervals in the radial direction. However, a shape of each of the heat-releasing fins and an arrangement of the heat-releasing fins are not limited to those described above. For example, as illustrated in FIG. 10, a plurality of arc-shaped heat-releasing fins 24a may be concentrically provided on the surface of the rear bracket-cum-cooler 14 on the heat-generating-component cooling flow passage 21 side, which includes the regions opposed to the heat-generating-component mounting portions 15a, so as to extend from the flow passage inlet 27a to the flow passage outlet 27b. The plurality of heat-releasing fins 24a are provided to extend along a flow direction of the cooling water flowing through the heat-generating-component cooling flow passage 21. With the arrangement described above, the cooling water smoothly flows through the heat-generating-component cooling flow passage 21 from the flow passage inlet 27a toward the flow passage outlet 27b along the plurality of heat-releasing fins 24a.

Further, as illustrated in FIG. 11, the heat-releasing fins may be heat-releasing fins 24b formed by separating the plurality of arc-shaped heat-releasing fins 24a, which are concentrically provided, in the circumferential direction into a plurality of sets through separating portions 30. In this case, the heat-releasing fins 24b, which are provided in a region from the flow passage inlet 27a to the flow passage outlet 27b, are separated in the circumferential direction into the plurality of sets through the separating portions 30. Thus, a pressure loss of the flow passage can be reduced. Further, the heat generating components 15 can be more efficiently cooled owing to a leading edge effect.

Further, the shape of each of the heat-releasing fins is not limited to the linear shape or the arc-like shape. As illustrated in FIG. 12, heat-releasing fins 24c each having a round pin-like shape may be used. As illustrated in FIG. 13, heat-releasing fins 24d each having a quadrangular prism shape may be used. Further, although not shown, the shape of each of the heat-releasing fins may be a columnar shape having a polygonal sectional shape, such as a pentagonal prism shape or a hexagonal prism shape. When a plurality of columnar heat-releasing fins as described above, each having a circular cross section or a polygonal cross section, are provided, the heat generating components 15 can be more efficiently cooled owing to the leading edge effect in comparison to a case in which the plurality of heat-releasing fins, each having a straight shape or the arc-like shape along the flow direction of the cooling water, are provided.

In the fifth embodiment described above, the shape of each of the heat-releasing fins and the arrangement of the heat-releasing fins are changed in the brushed rotating electric machine according to the third embodiment described above. However, the same effects are obtained even when the shape of each of the heat-releasing fins and the arrangement of the heat-releasing fins are similarly changed in the brushed rotating electric machines according to the first, second, and fourth embodiments described above.

### Sixth Embodiment

FIG. 14 is a sectional view for illustrating a brushed rotating electric machine according to a sixth embodiment of the present invention. FIG. 14 is a sectional view corresponding to the cross section taken along the line E-E of FIG. 7 when viewed in the direction of the arrows.

In this case, the sixth embodiment is different from the third embodiment only in the configuration of the bearing cooling flow passage 22. Thus, only differences are described, and description of other parts is omitted.

In FIG. 14, a bearing heat-releasing fin 25 having an arc-like shape is provided in the bearing cooling flow passage 22 so as to extend along the flow direction of the cooling water. The bearing cooling flow passage 22 is divided by the bearing heat-releasing fin 25 into two parts in the radial direction.

In the brushed rotating electric machine having the configuration described above, the bearing cooling flow passage 22 is divided by the bearing heat-releasing fin 25 into two parts in the radial direction. Thus, a radial dimension of the bearing cooling flow passage 22 is reduced, and a typical length (also referred to as “characteristic length”) is reduced. As a result, a flow rate of the cooling water in the bearing cooling flow passage 22 is increased. Hence, the heat generating components 15 can be more efficiently cooled.

In the sixth embodiment described above, the bearing heat-releasing fin is arranged in the bearing cooling flow passage in the brushed rotating electric machine according to the third embodiment described above. However, the same effects are obtained even when the bearing heat-releasing fin is arranged in the bearing cooling flow passage in the brushed rotating electric machines according to the second, fourth, and fifth embodiments described above.

### Seventh Embodiment

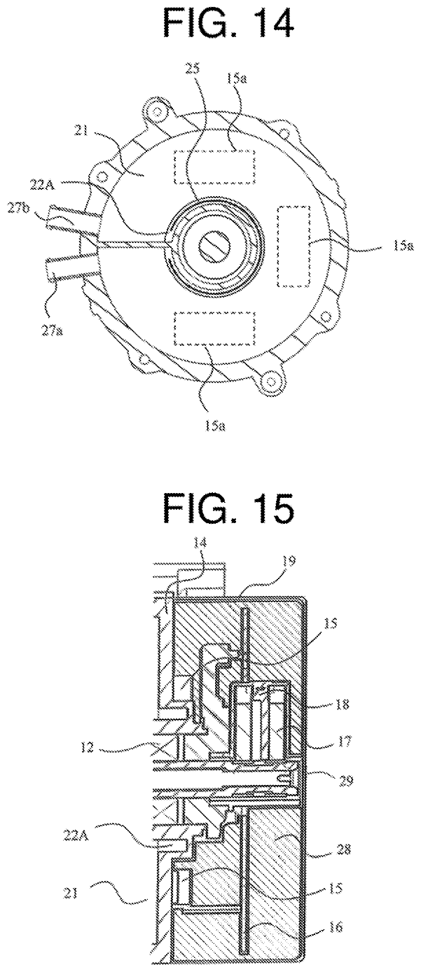

FIG. 15 is an enlarged sectional view for illustrating a main part of a brushed rotating electric machine according to a seventh embodiment of the present invention. FIG. 15 is an enlarged sectional view corresponding to an enlarged sectional view of a region F of FIG. 7.

In this case, the seventh embodiment is different from the third embodiment only in the configuration in which a resin member 28 is provided in a space formed by the rear bracket-cum-cooler 14 and the power converter cover 19 so as to fill the space. Thus, only differences are described, and description of other parts is omitted.

In FIG. 15, the resin member 28 is provided in the space formed by the rear bracket-cum-cooler 14 and the power converter cover 19 so as to fill an entire region of the space. The resin member 28 is made of an insulating resin material having a thermal conductivity larger than that of air.

In the brushed rotating electric machine having the configuration described above, the brush holder 18 and the rear bracket-cum-cooler 14 are joined together through the resin member 28 having a thermal conductivity larger than that of air. Thus, heat generated by sliding of the brushes 17 on the slip ring 29 and heat generated through energization of the brushes 17 are quickly transmitted to the rear bracket-cum-cooler 14 via the brush holder 18 and the resin member 28, and are released to the cooling water flowing through the heat-generating-component cooling flow passage 21. As a result, the brushes 17 are efficiently cooled.

Further, the heat generating components 15 and the rear bracket-cum-cooler 14 are joined together through the resin member 28. Thus, in addition to heat releasing paths from the heat generating components 15 through the heat-generating-member mounting portions 15a to the rear bracket-cum-cooler 14, heat releasing paths from the heat generating components 15 through the resin member 28 to the rear bracket-cum-cooler 14 are formed. With the heat releasing paths, the heat generating components 15 are also more efficiently cooled.

In the seventh embodiment described above, the resin member 28 is provided in the space between the rear bracket-cum-cooler 14 and the power converter cover 19 so as to fill the entire region of the space. However, the resin member 28 may be provided so as to fill only a part of the space as long as at least the brush holder 18 and the rear bracket-cum-cooler 14 are joined together.

Further, in the seventh embodiment described above, the resin member is provided inside the power converter cover 19 in the brushed rotating electric machine according to the third embodiment described above. However, the same effects are obtained even when the resin member is provided inside the power converter cover 19 in the brushed rotating electric machines according to the first, second, fourth, fifth, and sixth embodiments.

The embodiments of the present invention have been described. However, only examples are illustrated in the drawings referred to above, and the present invention may be embodied in various modes as described below.

The number of heat generating components is not limited to those illustrated in the drawings. Any number of heat generating components may be mounted as long as the number is equal to or larger than one.

Further, in the drawings, the cooling flow passages in which the cooling water flows in the circumferential direction are illustrated. However, for example, the cooling flow passages may be achieved in various shapes and arrangements such as a combination of a linear flow passage and a flow passage bent at a right angle or a combination of a linear flow passage and a U-shaped flow passage. The shape of each of the heat-releasing fins or the bearing heat-releasing fin and the arrangement thereof may be changed in accordance with the shapes and the arrangement of the cooling flow passages.

Further, the number of heat-releasing fins and the number of bearing heat-releasing fin are not limited to those illustrated in the drawings, and may be any numbers as long as each of the numbers is equal to or larger than one.

Further, the liquid refrigerant flowing through the heat-generating-component cooling flow passage and the bearing cooling flow passage is not limited to water, and may be, for example, an antifreeze liquid or oil.

Further, the flow passage inlet 27a and the flow passage outlet 27b, which are illustrated in FIG. 9 to FIG. 14, are oriented outward in the circumferential direction. However, the orientation thereof is not limited to that described above. A mounting structure may be appropriately changed so that the flow passage inlet 27a and the flow passage outlet 27b are oriented in the axial direction. For a mounting position relationship, mounting positions of the flow passage inlet 27a and the flow passage outlet 27b are not required to be adjacent to each other in proximity.

Further, the first to seventh embodiments have been described as different embodiments. However, a brushed rotating electric machine may be formed by appropriately combining characteristic configurations of the embodiments.

### REFERENCE SIGNS LIST

1 brushed rotating electric machine, 2 rotating machine unit, 3 power converter, 4 cooling unit, 5 rotary shaft, 6 rotor unit, 6a rotor core, 7 field winding, 8 front fan, 9 stator unit, 9a stator core, 10 stator winding, 10a winding exposed portion, 11 front bearing, 12 rear bearing, 13 front bracket, 13a intake hole, 13b discharge hole, 14 rear bracket-cum-cooler, 15 heat generating component, 15a heat-generating-component mounting portion, 17 brush, 18 brush holder, 19 power converter cover, 20 flow passage cover, 21 heat-generating-component cooling flow passage, 22, 22A bearing cooling flow passage, 23 heat-releasing member, 24, 24a, 24b, 24c, 24d heat-releasing fin, 25 bearing heat-releasing fin, 27a flow passage inlet, 27b flow passage outlet, 28 resin member, 29 slip ring

1. A rotating electric machine with a brush, comprising:
a rotating machine unit;
a power converter arranged on a rear side of the rotating machine unit; and
a cooling unit arranged between the rotating machine unit and the power converter, the rotating machine unit including:
a front bracket, which is formed in a bowl-like shape and has a front-side fitting portion formed at an opening edge, and in which a front bearing is mounted at an axial center position;
a rear bracket-cum-cooler, which is formed in a bowl-like shape and has a rear-side fitting portion formed at an opening edge, and in which a rear bearing is mounted at an axial center position,
a rotor unit including:
a rotor core;
a rotary shaft inserted into the rotor core at an axial center position to be integrated with the rotor core; and
a field winding mounted to the rotor core,
the rotary shaft being supported by the front bearing and the rear bearing so as to be rotatably arranged; and
a stator unit including:
a stator core; and
a stator winding mounted to the stator core,
the stator unit being pressurized and sandwiched between the front bracket and the rear bracket-cum-cooler on both sides in an axial direction of the rotary shaft under a state in which outer peripheral edge portions of both end portions of the stator core are fitted to the front-side fitting portion and the rear-side fitting portion to be arranged coaxially with the rotor unit so as to surround the rotor unit,
the power converter including:
at least one heat generating component to be mounted on a surface of the rear bracket-cum-cooler on a side opposite to the rotor unit;
a slip ring mounted to a projecting portion of the rotary shaft, which projects from the rear bearing;
a brush holder provided on an outer peripheral side of the slip ring;
brushes held in the brush holder so as to be in contact with the slip ring; and
a power converter cover, which is mounted to the rear bracket-cum-cooler, and is configured to cover the heat generating component, the brushes, and the brush holder,
the cooling unit including a heat-generating-component cooling flow passage and a bearing cooling flow passage, which are formed by mounting a flow passage cover to the rotor unit side of the rear bracket-cum-cooler,
wherein the flow passage cover has a dimension that is equal to or smaller than an inner diameter of the rear-side fitting portion and is larger than an outer diameter of the rotary shaft,
wherein the bearing cooling flow passage is an arc-shaped flow passage along a circumferential direction of the rotary shaft, and is arranged so that an arrangement region of the bearing cooling flow passage in an axial direction of the rotary shaft overlaps with at least a part of an arrangement region of the rear bearing in the axial direction of the rotary shaft, and
wherein the heat-generating-component cooling flow passage is arranged so as to overlap with at least a part of an arrangement region of the heat generating component when viewed in the axial direction of the rotary shaft.

2. The rotating electric machine with a brush according to claim 1, wherein the heat-generating-component cooling flow passage and the bearing cooling flow passage have an integrated structure.

3. The rotating electric machine with a brush according to claim 1, wherein a flow passage maximum dimension of the bearing cooling flow passage along the axial direction of the rotary shaft is larger than a flow passage maximum dimension of the heat-generating-component cooling flow passage along the axial direction of the rotary shaft.

4. The rotating electric machine with a brush according to claim 1, wherein a winding exposed portion of the stator winding, which is exposed from the stator core, is in contact with the flow passage cover through a heat-releasing member provided therebetween.

5. The rotating electric machine with a brush according to claim 1, wherein a dimension of a heat-generating-component mounting portion of the rear bracket-cum-cooler, on which the heat generating component is mounted, in the axial direction of the rotary shaft, is larger than a dimension of the flow passage cover in the axial direction of the rotary shaft.

6. The rotating electric machine with a brush according to claim 1, further comprising heat-releasing fins formed at least on a region of a surface of the rear bracket-cum-cooler, which forms the heat-generating-component cooling flow passage, the region overlapping with the heat generating component, so as to extend along a flow direction of a liquid refrigerant when viewed in the axial direction of the rotary shaft.

7. The rotating electric machine with a brush according to claim 6, wherein the heat-releasing fins are interrupted at least at one position in the flow direction of the liquid refrigerant.

8. The rotating electric machine with a brush according to claim 6, wherein the heat-releasing fins comprise pin fins each having a columnar shape.

9. The rotating electric machine with a brush according to claim 1, further comprising a bearing heat-releasing fin formed on a surface of the rear bracket-cum-cooler, which forms the bearing cooling flow passage, so as to extend along a flow direction of the liquid refrigerant.

10. The rotating electric machine with a brush according to claim 1, further comprising a resin member provided in a space formed by the rear bracket-cum-cooler and the power converter cover to fill the space so as to join the brush holder and the rear bracket-cum-cooler together.

11. The rotating electric machine with a brush according to claim 1, further comprising:
a front fan secured to a front-side end surface of the rotor core;
an intake hole formed in a portion of the front bracket, which is opposed to the rotor unit; and
a discharge hole formed in a portion of the front bracket on a radially outer side of the front fan.
